(19) United States
(12) Patent Application Publication
(10) Pub. No.: US 2018/0113627 A1
(43) Pub. Date: Apr. 26, 2018

(54) Method of Accessing Data for a Switch by Using Sub-flow Entry Tables

(71) Applicants: Inventec (Pudong) Technology Corp., Shanghai (CN); Inventec Corporation, Taipei (TW)

(72) Inventors: Pei-His Ting, Taipei (TW); Jheng-Jyun Wang, Taipei (TW); Chi-Hsiang Hung, Taipei (TW); Li-Chun Wang, Taipei (TW)

(21) Appl. No.: 15/466,849

(22) Filed: Mar. 22, 2017

(30) Foreign Application Priority Data
Oct. 25, 2016 (CN) 201610937727.1

(51) Int. Cl. G06F 3/06; H04L 12/24

(52) U.S. Cl. CPC G06F 3/0608; H04L 41/20; G06F 3/0673; G06F 3/0656; G06F 3/0647

(57) ABSTRACT

A method of accessing data for a switch includes vectorizing a flow entry to generate a flow entry vector, matching the flow entry vector and a stored vector of each first memory of a plurality of first memories for selecting a buffer address of the flow entry vector, and moving partial data of a first memory to a second memory when the first memory is selected to store the flow entry vector and a utilization rate of the first memory is greater than a predetermined value.

### BACKGROUND OF THE INVENTION

### 1. Field of the Invention

The present invention illustrates a method of accessing data for a switch, and more particularly, a method of accessing data for the switch by using sub-flow entry tables in order to improve capacity for buffering the accessing data.

### 2. Description of the Prior Art

With advancements of cloud computing system, virtualization technique becomes an important issue in our daily life. The idea of virtualization technique is to use several virtual machines instead of a physical host server. These virtual machines are operated in parallel and can provide reliable service quality. However, when the virtualization technique is applied to cloud computing system, the data center network requires massive computational complexity, computational capability, and data storage capacity. Thus, a soft defined network (SDN) system in conjunction with Openflow structure is developed by Stanford University. The original propose is to extend the programmable capability for campus network and provide the corresponding virtualization client interface. Generally, the SDN includes a centralized controller and thousands of switches. These switches are interconnected and coupled to all physical host servers through complex transmission paths. Specifically, these interconnected switches are assigned according to a topology structure. In other words, the data center network under the SDN is established according to the topology structure.

In general, the Openflow structure follows a public SDN standard. In the SDN standard, 40 match fields are used for forming a communication protocol. Thus, numerous bits are required to store each intact flow entry, leading to enormous time consumption for matching all fields. To improve operational efficiency, a ternary content address memory (TCAM) is introduced to access data in a flow entry table. Specifically, the TCAM is capable of matching all match fields in parallel in conjunction with high data accessing efficiency. However, the TCAM requires higher circuit layout area and higher cost than a static random access memory (SRAM). For this reason, in a conventional 10 Gigabyte (10-Gb) Ethernet switch, only several thousands of flow entries can be buffered to the TCAM with limited capacity. When the flow entries buffered in the switch are insufficient, some transmission routes of packets cannot be directly acquired according to the flow entries buffered in the TCAM. Thus, a request signal is transmitted from the switch to the network controller for processing the packets with unknown transmission routes. In other words, since conventional switch uses the TCAM with limited capacity, when the buffered flow entries of the switch are insufficient, the switch is required to negotiate with the network controller frequently, leading to increase transmitted delay.

Further, the conventional switch lacks of data optimization process, such as adding, updating, and deleting process of the flow entries. Thus, when the flow entries are varied frequently, operational efficiency of the switch may be decreased.

### SUMMARY OF THE INVENTION

In an embodiment of the present invention, a method of accessing data for a switch is disclosed. The switch comprises a control circuit and a chip circuit. The chip circuit comprises a plurality of first memory devices. The control circuit comprises a second memory device. The method comprises vectorizing a flow entry received by the switch for generating a flow entry vector, matching the flow entry vector and a stored vector of each first memory device of the plurality of first memory devices for selecting a buffer address of the flow entry vector, and moving partial data from a first memory device to the second memory device when the first memory device of the plurality of first memory devices is selected to store the flow entry vector and a utilization factor of the first memory device is greater than a predetermined value.

The method of accessing data in the present invention belongs to a method for performing high data accessing efficiency and improving operational efficiency under a soft defined network (SDN) or internet of things (IoT) network.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic structure of a switch under a soft defined network according to an embodiment of the present invention.

FIG. 2 is a flow chart of a method for accessing data of the switch in FIG. 1.

FIG. 3 is a flow chart of a data compression method by using statistical table information.

### DETAILED DESCRIPTION

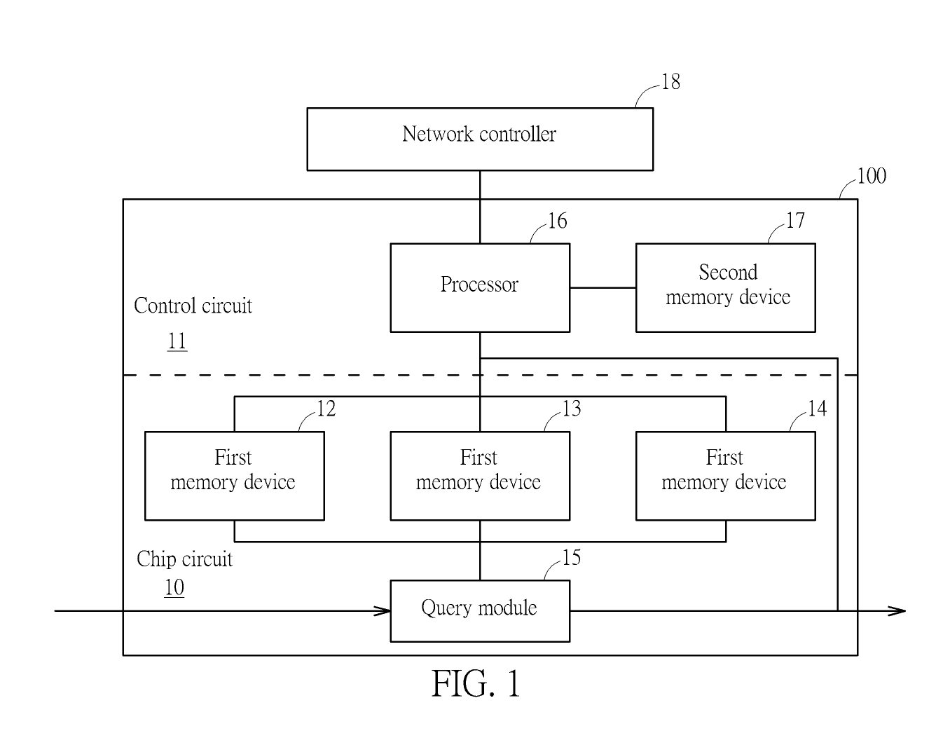

FIG. 1 is a schematic structure of a switch 100. Here, a method of accessing data in an embodiment of the present invention can be applied to any type of topologies under a soft defined network (SDN). For example, the switch 100 illustrated in FIG. 1 can be denoted as a switch for OpenFlow protocol under the SDN. However, the present invention is not limited to use the switch 100 in FIG. 1. The switch 100 includes a control circuit 11 and a chip circuit 10. The control circuit 11 can be an ASIC (application-specific integrated circuit) side on a data plane. The chip circuit 10 can be a central processing unit side on a control plane. The chip circuit 10 includes a plurality of first memory devices. For example, the chip circuit 10 includes a first memory device 12 for storing a media access control table (MAC Table), a first memory device 13 for storing an internet protocol table (IP Table), and a first memory device 14 for storing an access control list table (ACL Table). The first memory devices 12 and 13 can be two static random access memory (SRAM) devices. The first memory device 14 can be a ternary content address memory (TCAM) device. The chip circuit 10 further includes a query module 15. When the switch 100 is prepared to output a packet, the switch 100 can try to search information of transmission routes from the first memory devices 12 to 14 through the query module 15. If the flow entry corresponding to the packet is successfully searched through the query module 15, the packet can be transmitted from the switch 100 according to the information of transmission routes of the flow entry. In the chip circuit 10, the first memory devices 12 to 14 are coupled to the query module 15. The control circuit 11 includes a processor 16 and a second memory device 17. The processor 16 can be a flow entry agent or any programmable or a logical unit. The processor 16 is coupled to the second memory device 17. The second memory device 17 can be a static random access memory device for storing a sub-flow entry table. A table-generation method and a table-amendment method of the sub-flow entry table are illustrated later. The processor 16 is coupled to the chip circuit 10 and a network controller 18 outside the switch 100. Particularly, the network controller 18 can be an SDN-based network controller. When the processor 16 is capable of performing functions of the flow entry agent, the processor 16 can receive a request message from the chip circuit 10 (i.e., a pseudo packet-in message). Then, the processor 16 can negotiate with the network controller 18 according to the request message. In the switch 100, the first memory device 12 and the first memory device 13 may only store match fields corresponding MAC data and IP data. In other words, other match fields are stored in the first memory device 14 (TCAM device). Unfortunately, in the SDN using the OpenFlow protocol, the first memory device 14 (TCAM device) of the switch 100 is constrained by a capacity limitation capable of storing 2000 to 8000 flow entries if the switch 100 uses a conventional data accessing method. To improve memory capacity for storing additional flow entries, a proposed method of accessing data of the switch 100 is disclosed in the present invention without any hardware modification. The method of accessing data is illustrated below.

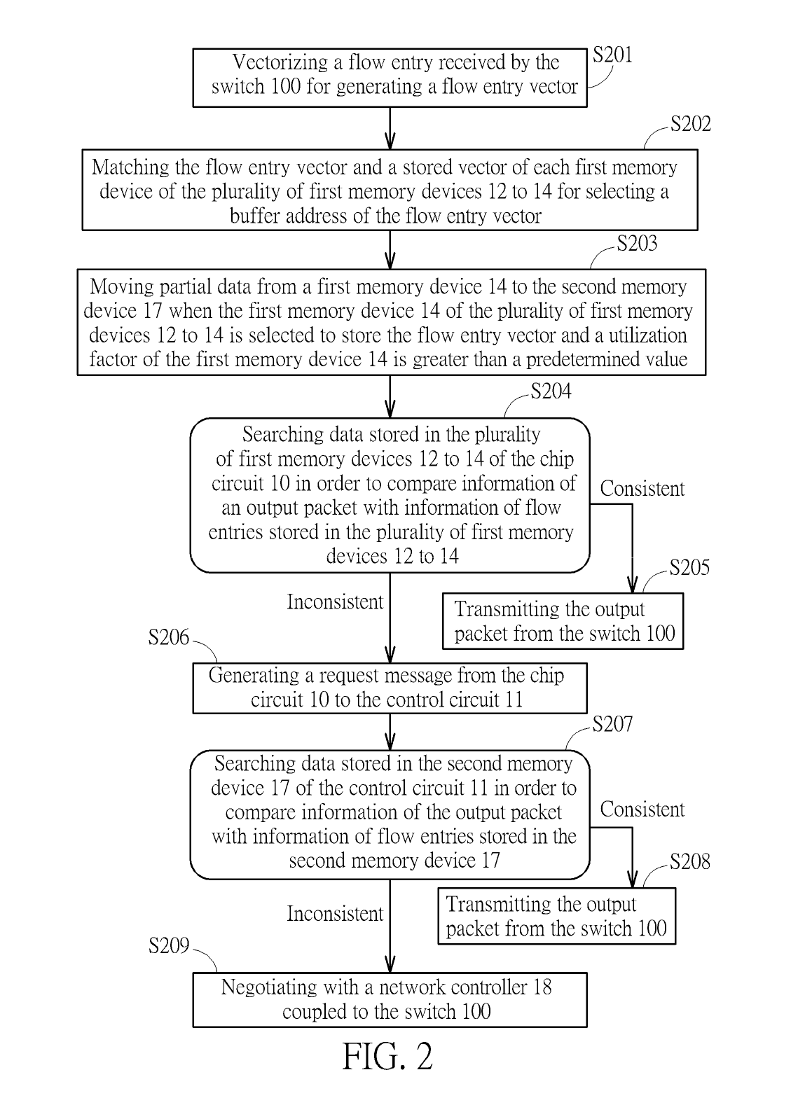

FIG. 2 is a flow chart of a method for accessing data of the switch 100. The method for accessing data of the switch 100 includes
step S201 to step S209, as:
step S201: vectorizing a flow entry received by the switch 100 for generating a flow entry vector;
step S202: matching the flow entry vector and a stored vector of each first memory device of the plurality of first memory devices 12 to 14 for selecting a buffer address of the flow entry vector;
step S203: moving partial data from a first memory device 14 to the second memory device 17 when the first memory device 14 of the plurality of first memory devices 12 to 14 is selected to store the flow entry vector and a utilization factor of the first memory device 14 is greater than a predetermined value;
step S204: searching data stored in the plurality of first memory devices 12 to 14 of the chip circuit 10 in order to compare information of an output packet with information of flow entries stored in the plurality of first memory devices 12 to 14; when the information of the output packet and the information of the flow entries are consistent, executing step S205; when the information of the output packet and the information of the flow entries are inconsistent, executing step S206;
step S205: transmitting the output packet from the switch 100.
step S206: generating a request message from the chip circuit 10 to the control circuit 11;
step S207: searching data stored in the second memory device 17 of the control circuit 11 in order to compare information of the output packet with information of flow entries stored in the second memory device 17; when the information of the output packet and the information of flow entries are consistent, executing step S208; when the information of the output packet and the information of flow entries are inconsistent, executing step S209;
step S208: transmitting the output packet from the switch 100.
step S209: negotiating with a network controller 18 coupled to the switch 100.

Each step is illustrated as below. In step S201, the switch 100 receives a flow entry and performs a vectorizing process for generating the flow entry vector according to the flow entry. In the SDN standard, a flow entry includes several match fields, such as a match field of a switch input port (hereafter, say “IN_PORT”), a match field of an Ethernet destination (hereafter, say “ETH_DST”), a match field of an Ethernet source (hereafter, say “ETH_SRC”), a match field of an Ethernet structure type (hereafter, say “ETH_TYPE”), a match field of an internet protocol (hereafter, say “IP_PROTO”), a match field of an internet protocol version 4 source (hereafter, say “IPv4_SRC”), a match field of an internet protocol version 4 destination (hereafter, say “IPv4_DST”), a match field of an internet protocol version 6 source (hereafter, say “IPv6_SRC”), a match field of an internet protocol version 6 destination (hereafter, say “IPv6_DST”), a match field of a transmission control protocol source port (hereafter, say “TCP_SRC_P”), a match field of a transmission control protocol destination port (hereafter, say “TCP_DST_P”), a match field of a user datagram protocol source port (hereafter, say “UDP_SRC_P”), and a match field of a user datagram protocol destination port (hereafter, say “UDP_DST_P”). For presentation completeness, memory requirement of each match field is listed in Table 1.

TABLE 1

| match field | bits | match field | bits |
|---|---|---|---|
| IN_PORT | 32 | IPv6_SRC | 128 |
| ETH_DST | 48 | IPv6_DST | 128 |
| ETH_SRC | 48 | TCP_SRC_P | 16 |
| ETH_TYPE | 16 | TCP_DST_P | 16 |
| IP_PROTO | 8 | UDP_SRC_P | 16 |
| IPv4_SRC | 32 | UDP_DST_P | 16 |
| IPv4_DST | 32 | | |

In step S201, the switch 100 can generate the flow entry vector from the flow entry according to match fields listed in Table 1. For example, the switch 100 can generate a binary flow entry vector as “0110000000000”. Specifically, match fields of the binary flow entry vector “0110000000000” can be illustrated in Table 2.

TABLE 2

| match field | bits | status | match field | bits | status |
|---|---|---|---|---|---|
| IN_PORT | 32 | 0 | IPv6_SRC | 128 | 0 |
| ETH_DST | 48 | 1 | IPv6_DST | 128 | 0 |
| ETH_SRC | 48 | 1 | TCP_SRC_P | 16 | 0 |
| ETH_TYPE | 16 | 0 | TCP_DST_P | 16 | 0 |
| IP_PROTO | 8 | 0 | UDP_SRC_P | 16 | 0 |
| IPv4_SRC | 32 | 0 | UDP_DST_P | 16 | 0 |
| IPv4_DST | 32 | 0 | | | |

In Table 2, a bit status “0” corresponds to a “significant field”. A bit status “1” corresponds to an “insignificant field”. For the binary flow entry vector “0110000000000”, the significant fields include the match field ETH_DST and the match field ETH_SRC. The insignificant fields include the match field ETH_TYPE, the match field IP_PROTO, the match field IPv4_SRC, the match field IPv4_DST, the match field IPv6_SRC, the match field IPv6_DST, the match field TCP_SRC_P, the match field TCP_DST_P, the match field UDP_SRC_P, and the match field UDP_DST_P. Specifically, the “significant field” is defined as a match field required for comparing data. The “insignificant field” is defined as a match field which can be ignored. By vectorizing the flow entry in step S201, the significant fields and the insignificant field can be obtained directly.

In step S202, the flow entry vector and the stored vector of each first memory device of the plurality of first memory devices 12 to 14 are matched for selecting the buffer address of the flow entry vector. Specifically, a vector-product based match process is introduced in step S202. In other words, an inner product of the flow entry vector and a cross product between the stored vector of each first memory device of the plurality of first memory devices 12 to 14 and the flow entry vector are matched. When the inner product of the flow entry vector is equal to a cross product between a certain stored vector of the first memory device and the flow entry vector, the flow entry vector is buffered to the first memory device. For example, a binary flow entry vector “0110000000000” is denoted as a vector E. A stored vector S_{MAC} of the first memory device 12 (i.e., for storing the MAC Table) is denoted as a vector S_{MAC}=“0110000000000”. A stored vector S_{IP} of the first memory device 13 (i.e., for storing the IP Table) is denoted as a vector S_{IP}=“0000011000000”. Here, an inner product of the flow entry vector E is equal to (E·E=2). A cross product between the stored vector S_{MAC} and the flow entry vector E is equal to (E·S_{MAC}=2). Since (E·E)=(E·S_{MAC}) holds, the flow entry vector E is stored in the first memory device 12. Further, the inner product of the flow entry vector E is equal to (E·E=2). A cross product between the stored vector S_{IP} and the flow entry vector E is equal to (E·S_{IP}=0). The flow entry vector E is not stored in the first memory device 13 because of (E·E)≠(E·S_{IP}). However, different flow entry vector E leads to different result. For example, when a binary expression of the flow entry vector E is considered as “0000000011111”, an inner product of the flow entry vector E is equal to (E·E=5). A cross product between the stored vector S_{MAC} and the flow entry vector E is equal to (E·S_{MAC}=0). A cross product between the stored vector S_{IP} and the flow entry vector E is equal to (E·S_{IP}=0). Thus, the flow entry vector E is not stored in the first memory device 12 or 13 because (E·E)≠(E·S_{MAC}) and (E·E)≠(E·S_{IP}). Further, a cross product between a stored vector S_{TCAM}=“1111111111111” of the first memory device 14 and the flow entry vector E is equal to (E·S_{TCAM}=5). Since (E·E)=(E·S_{TCAM}) holds, the flow entry vector E is stored in the first memory device 14. In other words, since the stored vector S_{TCAM} of the first memory device 14 is “1111111111111”, the flow entry vector E which failed to satisfy (E·E)=(E·S_{MAC}) and (E·E)=(E·S_{IP}) has to satisfy (E·E)=(E·S_{TCAM}). Briefly, when the flow entry vector E is forbidden to be stored in the first memory device 12 and the first memory device 13, the flow entry vector E can be stored in the first memory device 14.

As mentioned previously, since the first memory device 14 (i.e., TCAM device) has limited capacity, in step S203, when a utilization factor of the first memory device 14 is greater than a predetermined value, a data compression process is triggered. Then, the partial data from a first memory device 14 of the switch 100 is moved to the second memory device 17. Particularly, a table-based data compression method is introduced for moving partial data from a first memory device 14 to the second memory device 17. Further, a table division algorithm is further used for improving data compression efficiency. The table-based data compression method and the table division algorithm are illustrated later. By integrating several heterogeneous memory devices (i.e., the first memory 14 and the second memory 17) in step S203, the flow entry vector can be stored (or say, buffered) to the first memory device 14 inside the on-chip circuit (chip circuit 10) or the second memory device 17 inside the off-chip circuit (control circuit 11). Equivalently, the storage capacity of the switch 100 is increased. The switch 100 can store additional flow entries. Further, the predetermined value (upper bound) of the utilization factor can be equal to 95%. However, the present invention is not limited to use a specific value of the utilization factor for triggering the data compression process.

In step S204, the switch 100 searches data stored in the plurality of first memory devices 12 to 14 in order to compare information of an output packet with information of flow entries stored in the plurality of first memory devices 12 to 14. As known, in the SDN, transmission routes optimization and transmission routes migration optimization are two main issues for providing high communication quality and high quality of service (QOS). Thus, the switch 100 searches an appropriate flow entry of the output packet for optimizing the transmission routes of the output packet according to the appropriate flow entry. As mentioned previously, since the flow entries may be stored in the plurality of first memory devices 12 to 14, the switch 100 firstly searches information of flow entries stored in the plurality of first memory devices 12 to 14. When the information of the output packet and the information of the flow entries are consistent, the output packet is transmitted from the switch 100 in step S205. When the information of the output packet and the information of the flow entries (i.e., stored in the first memory devices 12 to 14) are inconsistent, a pseudo packet-in request process is triggered. Then, the chip circuit 10 generates a request message of pseudo packet-in to the control circuit 11 in step S206. In step S207, the switch 100 searches data stored in the second memory device 17 of the control circuit 11 in order to compare information of the output packet with information of flow entries stored in the second memory device 17. Similarly, when the information of the output packet and the information of flow entries are consistent, the output packet is transmitted from the switch 100 in step S208. When the information of the output packet and the information of flow entries are inconsistent (i.e., stored in the second memory devices 17), the switch 100 negotiates with a network controller 18 coupled to the switch 100 in step S209. As mentioned previously, since the switch integrates several heterogeneous memory devices (i.e., the first memory 14 of the on-chip side and the second memory 17 of the off-chip side), the memory capacity can be increased. Thus, additional flow entry vectors can be stored to the switch 100. As a result, by using data searching/accessing method in step S201 to step S209, the frequency of negotiations with the network controller 18 can be reduced. Therefore, bandwidth requirement and transmission delay caused by pseudo packet-in request can also be mitigated.

As aforementioned illustration, in step S203, a table-based data compression method can be introduced for moving partial data from a first memory device 14 to the second memory device 17. Further, a table division algorithm can be further used for improving data compression efficiency. In the following, the table-based data compression method in conjunction with table division algorithm is described.

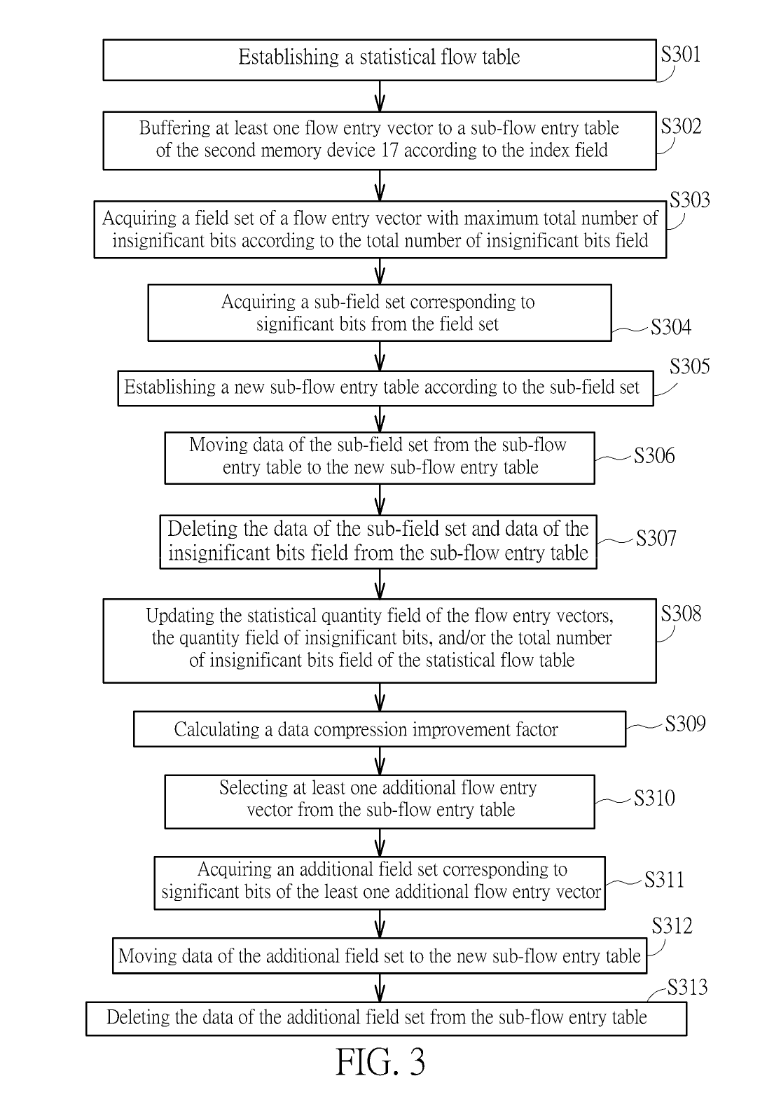

FIG. 3 is a flow chart of a data compression method by using statistical table information. The data compression method includes
step S301 to step S313, as:
step S301: establishing a statistical flow table, where the statistical flow table includes a statistical quantity field of the flow entry vectors, an index field, a quantity field of insignificant bits, and a total number of insignificant bits field;
step S302: buffering at least one flow entry vector to a sub-flow entry table of the second memory device 17 according to the index field;
step S303: acquiring a field set of a flow entry vector with maximum total number of insignificant bits according to the total number of insignificant bits field;
step S304: acquiring a sub-field set corresponding to significant bits from the field set;
step S305: establishing a new sub-flow entry table according to the sub-field set;
step S306: moving data of the sub-field set from the sub-flow entry table to the new sub-flow entry table;
step S307: deleting the data of the sub-field set and data of the insignificant bits field from the sub-flow entry table;
step S308: updating the statistical quantity field of the flow entry vectors, the quantity field of insignificant bits, and/or the total number of insignificant bits field of the statistical flow table;
step S309: calculating a data compression improvement factor, where the data compression improvement factor is a ratio of the number of insignificant bits of the flow entry vector with maximum total number of insignificant bits to the total number of insignificant bits of the sub-flow entry table;
step S310: selecting at least one additional flow entry vector from the sub-flow entry table;
step S311: acquiring an additional field set corresponding to significant bits of the least one additional flow entry vector;
step S312: moving data of the additional field set to the new sub-flow entry table;
step S313: deleting the data of the additional field set from the sub-flow entry table.

In step S301, the switch 100 establishes the statistical flow table corresponding to the second memory device 17. Specifically, the statistical flow table includes the statistical quantity field of the flow entry vectors, the index field, the quantity field of insignificant bits, and the total number of insignificant bits field. For example, the second memory device 17 is prepared to store eight flow entry vectors. The eight flow entry vectors can be categorized as four types, such as “100011111”, “100110000”, “111110000”, and “111111111”. The switch 100 can establish a statistical flow table A, as illustrated below.

Statistical flow table A

| Type | 100011111 | 100110000 | 111110000 | 111111111 |
|---|---|---|---|---|
| statistical | 2 | 1 | 3 | 2 |
| quantity field | | | | |
| of the flow | | | | |
| entry vectors | | | | |
| index field | sub-flow | sub-flow | sub-flow | sub-flow |
| | entry | entry | entry | entry |
| | table SA | table SA | table SA | table SA |
| quantity field | 112 | 192 | 96 | 0 |
| of insignificant | | | | |
| bits (per flow) | | | | |
| total number | 224 | 192 | 288 | 0 |
| of insignificant | | | | |
| bits field | | | | |

In the statistical flow table A, two flow entry vectors belong to a type “100011111”. One flow entry vector belongs to a type “100110000”. Three flow entry vectors belong to a type “111110000”. Two flow entry vectors belong to a type “111111111”. All flow entry vectors are stored in the sub-flow entry table SA. Each flow entry vector categorized as type “100011111” has 112 insignificant bits (i.e., an insignificant bit is denoted as “0” for binary expression). Since the type “100011111” includes two flow entry vectors, the total number of insignificant bits of the type “100011111” is 224. Each flow entry vector categorized as type “100110000” has 192 insignificant bits. Since the type “100110000” includes one flow entry vector, the total number of insignificant bits of the type “100110000” is 192. Each flow entry vector categorized as type “111111111” has no insignificant bit because all bits of the type “111111111” are “1”. Thus, the total number of insignificant bits of the type “111111111” is zero.

In the following step S302, the switch 100 buffers at least one flow entry vector to the sub-flow entry table of the second memory device 17 according to the index field. For example, the index field of the statistical flow table A indicates an address for storing the at least one flow entry vector to a sub-flow entry table SA. Therefore, the sub-flow entry table SA of the second memory device 17 is used for storing data of the flow entry vectors listed in the statistical flow table A. For example, aforementioned eight flow entry vectors can be stored in the sub-flow entry table SA, as illustrated below.

Sub-flow entry table SA

| | IN_PORT | ETH_DST | ETH_SRC | ETH_TYPE | IP_PROTO | IPv4_SRC | IPv4_DST | TCP_SRC | TCP_DST |
|---|---|---|---|---|---|---|---|---|---|
| E1 | 1 | 0 | 0 | 0 | 1 | 1 | 1 | 1 | 1 |
| E2 | 1 | 0 | 0 | 0 | 1 | 1 | 1 | 1 | 1 |
| E3 | 1 | 0 | 0 | 1 | 1 | 0 | 0 | 0 | 0 |
| E4 | 1 | 1 | 1 | 1 | 1 | 0 | 0 | 0 | 0 |
| E5 | 1 | 1 | 1 | 1 | 1 | 0 | 0 | 0 | 0 |
| E6 | 1 | 1 | 1 | 1 | 1 | 0 | 0 | 0 | 0 |
| E7 | 1 | 1 | 1 | 1 | 1 | 1 | 1 | 1 | 1 |
| E8 | 1 | 1 | 1 | 1 | 1 | 1 | 1 | 1 | 1 |

In the sub-flow entry table SA, the flow entry vectors E1 and E2 belong to the type “100011111”. The flow entry vector E3 belongs to the type “100110000”. The flow entry vectors E4 to E6 belong to the type “111110000”. The flow entry vectors E7 and E8 belong to the type “111111111”.

In step S303, the switch 100 can acquire a field set of a flow entry vector with maximum total number of insignificant bits according to the total number of insignificant bits field. For example, in the statistical flow table A, a type with maximum total number of insignificant bits is “111110000”, which has 288 total insignificant bits. In the sub-flow entry table SA, the type “111110000” corresponds to the flow entry vector E4, the flow entry vector E5, and the flow entry vector E6. Thus, a field set includes match fields of the flow entry vectors E4 to E6 is selected. In the following step S304, the switch 100 can acquire a sub-field set corresponding to significant bits from the field set. As mentioned previously, the flow entry vectors E4 to E6 can be expressed as the type “111110000”. Specifically, an insignificant bit is denoted as “0” for binary expression. A significant bit is denoted as “1” for binary expression. Thus, in flow entry vectors with type “111110000”, a match field IN_PORT, a match field ETH_DST, a match field ETH_SRC, a match field ETH_TYPE, and a match field IP_PROTO belong to significant match fields. A match field IPv4_SRC, a match field IPv4_DST, a match field TCP_SRC, and a match field TCP_DST belong to insignificant match fields. In step S304, the field set includes the match field IN_PORT, the match field ETH_DST, the match field ETH_SRC, the match field ETH_TYPE, and the match field IP_PROTO.

In step S305 and step S306, the switch 100 can establish a new sub-flow entry table SB. Then, the switch 100 moves data of the sub-field set from the sub-flow entry table SA to the new sub-flow entry table SB. For example, the new sub-flow entry table SB can be established according to the field set. Then, the switch 100 moves the significant match fields of the flow entry vector E4, the flow entry vector E5, and the flow entry vector E6 from the sub-flow entry table SA to the new sub-flow entry table SB. By doing so, the new sub-flow entry table SB can be expressed as

New Sub-flow entry table SB

| | IN_PORT | ETH_DST | ETH_SRC | ETH_TYPE | IP_PROTO |
|---|---|---|---|---|---|
| E4 | 1 | 1 | 1 | 1 | 1 |
| E5 | 1 | 1 | 1 | 1 | 1 |
| E6 | 1 | 1 | 1 | 1 | 1 |

In the new sub-flow entry table SB, only the significant match fields (i.e., corresponding to bit “1”) of the flow entry vector E4, the flow entry vector E5, and the flow entry vector E6 are stored. In other words, the insignificant match fields (i.e., corresponding to bit “0”) are not stored to the new sub-flow entry table SB. Therefore, by introducing the new sub-flow entry table SB, memory utilization efficiency can be improved. Further, since the data of the flow entry vector E4, the flow entry vector E5, and the flow entry vector E6 of the sub-flow entry table SA is moved to the new sub-flow entry table SB, the data of the sub-field set and data of the insignificant bits field from the sub-flow entry table SA can be deleted by the switch 100 in step S307. For example, the data of the flow entry vector E4, the flow entry vector E5, and the flow entry vector E6 is deleted from the sub-flow entry table SA. The switch 100 can use line-deleted method to eliminate data of flow entry vectors E4 to E6 from the sub-flow entry table SA. After the data of flow entry vectors E4 to E6 is deleted from the sub-flow entry table SA, the sub-flow entry table SA can be updated as the sub-flow entry table SA1. To avoid ambiguity, the sub-flow entry table updated from the sub-flow entry table SA is denoted as the sub-flow entry table SA1 hereafter. The sub-flow entry table SA1 can be written as

Sub-flow entry table SA1

| | IN_PORT | ETH_DST | ETH_SRC | ETH_TYPE | IP_PROTO | IPv4_SRC | IPv4_DST | TCP_SRC | TCP_DST |
|---|---|---|---|---|---|---|---|---|---|
| E1 | 1 | 0 | 0 | 0 | 1 | 1 | 1 | 1 | 1 |
| E2 | 1 | 0 | 0 | 0 | 1 | 1 | 1 | 1 | 1 |
| E3 | 1 | 0 | 0 | 1 | 1 | 0 | 0 | 0 | 0 |
| E7 | 1 | 1 | 1 | 1 | 1 | 1 | 1 | 1 | 1 |
| E8 | 1 | 1 | 1 | 1 | 1 | 1 | 1 | 1 | 1 |

In the sub-flow entry table SA1, since the data of flow entry vectors E4 to E6 is deleted, the statistical quantity field of the flow entry vectors, the quantity field of insignificant bits, and/or the total number of insignificant bits field of the statistical flow table A can be updated synchronously in step S308. To avoid ambiguity, the statistical flow table updated from the statistical flow table A is denoted as a statistical flow table A1 hereafter. The statistical flow table A1 can be written as

Statistical flow table A1

| Type | 100011111 | 100110000 | 111110000 | 111111111 |
|---|---|---|---|---|
| statistical | 2 | 1 | 3 | 2 |
| quantity field | | | | |
| of the flow | | | | |
| entry vectors | | | | |
| index field | sub-flow | sub-flow | New | sub-flow |
| | entry | entry | sub-flow | entry |
| | table SA | table SA | entry | table SA |
| | | | table SB | |
| quantity field | 112 | 192 | 0 | 0 |
| of insignificant | | | | |
| bits (per flow) | | | | |
| total number | 224 | 192 | 0 | 0 |
| of insignificant | | | | |
| bits field | | | | |

In the statistical flow table A1, since the data of the flow entry vectors E4 to E6 with the type “111110000” is moved from the sub-flow entry table SA to the new sub-flow entry table SB, the index field indicates an address as the new sub-flow entry table SB for storing the data of flow entry vectors E4 to E6 with the type “111110000”. As mentioned previously, only the significant match fields (i.e., corresponding to bit “1”) of the flow entry vector E4, the flow entry vector E5, and the flow entry vector E6 are stored in the new sub-flow entry table SB. Thus, each flow entry vector categorized as type “111110000” stored in the new sub-flow entry table SB has no insignificant bit. The total number of insignificant bits of the flow entry vectors categorized as type “111110000” stored in the new sub-flow entry table SB is zero (3×0=0).

By processing step S301 to step S308, data compression can be performed. A principle of data compression is briefly illustrated below. In the original sub-flow entry table SA, numerous insignificant bits (i.e., 288 bits) exist in the flow entry vector E4, the flow entry vector E5, and the flow entry vector E6, thereby requiring large memory capacity. To perform data compression without any information loss, the significant bits of the flow entry vector E4, the flow entry vector E5, and the flow entry vector E6 are selected by the switch 100. Further, the data of the significant bits is stored to the new sub-flow entry table SB. Finally, the data of the flow entry vector E4, the flow entry vector E5, and the flow entry vector E6 are deleted from the sub-flow entry table SA. Therefore, numerous insignificant bits (i.e., 288 bits) can be eliminated for releasing the memory capacity. For the second memory device 17, since the data compression process is performed, some memory capacity can be released for storing additional flow entry vectors. However, the following step S309 to step S313 can be optionally executed for further improving the data compression efficiency. Step S309 to step S313 are illustrated below.

In step S309, the switch 100 calculates a data compression improvement factor. A definition of the data compression improvement factor is a ratio of the number of insignificant bits of the flow entry vector with maximum total number of insignificant bits to the total number of insignificant bits of the sub-flow entry table. For the sub-flow entry table SA, the flow entry vector with maximum total number of insignificant bits belongs to the type “111110000”. Therefore, a numerator of the data compression improvement factor is the number of insignificant bits (bit “0”) of “111110000”. A denominator of the data compression improvement factor is the total number of insignificant bits of “111110000” (i.e., 288 bits) in the sub-flow entry table SA. In another embodiment, when the switch 100 selects flow entry vectors with the type “111111100”, since only two insignificant bits can be eliminated for data compression, the data compression improvement factor is inferior to the selected type “111110000”. However, data compression improvement factor can be calculated at any moment. Also, data compression improvement factor can be periodically calculated for continuously monitoring a memory status. Also, the switch 100 can ignore step S309 and proceed to execute the following step S310.

To further improve the data compression efficiency, step S310 can be executed. In step S310, the switch 100 selects at least one additional flow entry vector from the sub-flow entry table SA1. For example, a flow entry vector E3 is selected by the switch 100 from the sub-flow entry table SA1. Specifically, the flow entry vector E3 in the sub-flow entry table SA1 can be expressed as

Flow entry vector E3

| | IN_PORT | ETH_DST | ETH_SRC | ETH_TYPE | IP_PROTO | IPv4_SRC | IPv4_DST | TCP_SRC | TCP_DST |
|---|---|---|---|---|---|---|---|---|---|
| E3 | 1 | 0 | 0 | 1 | 1 | 0 | 0 | 0 | 0 |

Here, there are some limitations for selecting the flow entry vector E3 by the switch 100. In other words, the flow entry vector E3 has to satisfy a following condition. A field set including significant match fields of the flow entry vector E3 is a sub-set of significant match fields of the flow entry vectors E4 to E6. For example, the field set including significant match fields of the flow entry vector E3 is {IN_PORT, ETH_TYPE, IP_PROTO}. The significant match fields of the flow entry vectors E4 to E6 is {IN_PORT, ETH_DST, ETH_SRC, ETH_TYPE, IP_PROTO}. Particularly, since {IN_PORT, ETH_TYPE, IP_PROTO} is the sub-set of {IN_PORT, ETH_DST, ETH_SRC, ETH_TYPE, IP_PROTO}, the flow entry vector E3 can be selected by the switch 100.

In step S311, the switch 100 acquires an additional field set corresponding to significant bits of the least one additional flow entry vector. As mentioned previously, the switch 100 acquires the additional field set {IN_PORT, ETH_TYPE, IP_PROTO} corresponding to significant bits of the flow entry vector E3. Further, in step S312, the switch 100 can move data of the additional field set from the sub-flow entry table SA1 to a new sub-flow entry table SB1. In other words, the new sub-flow entry table SB is updated to the new sub-flow entry table SB1, as

New sub-flow entry table SB1

| | IN_PORT | ETH_DST | ETH_SRC | ETH_TYPE | IP_PROTO |
|---|---|---|---|---|---|
| E4 | 1 | 1 | 1 | 1 | 1 |
| E5 | 1 | 1 | 1 | 1 | 1 |
| E6 | 1 | 1 | 1 | 1 | 1 |
| E3 | 1 | 0 | 0 | 1 | 1 |

In step S313, the data of the additional field set from the sub-flow entry table SA1 is deleted by the switch 100. Similarly, the data of the flow entry vector E3 is deleted from the sub-flow entry table SA1. For example, the switch 100 can use a line-deleted method to eliminate data of flow entry vector E3 from the sub-flow entry table SA1. Then, the sub-flow entry table SA1 is updated to a sub-flow entry table SA2. Therefore, the sub-flow entry table SA2 includes the flow entry vector E1, the flow entry vector E2, the flow entry vector E7, and the flow entry vector E8. Particularly, since there are a lot of significant bits in the flow entry vector E1, the flow entry vector E2, the flow entry vector E7, and the flow entry vector E8, data compression efficiency can be further improved by updating the sub-flow entry table SA1 to the sub-flow entry table SA2. The sub-flow entry table SA2 can be expressed as

Sub-flow entry table SA2

| | IN_PORT | ETH_DST | ETH_SRC | ETH_TYPE | IP_PROTO | IPv4_SRC | IPv4_DST | TCP_SRC | TCP_DST |
|---|---|---|---|---|---|---|---|---|---|
| E1 | 1 | 0 | 0 | 0 | 1 | 1 | 1 | 1 | 1 |
| E2 | 1 | 0 | 0 | 0 | 1 | 1 | 1 | 1 | 1 |
| E7 | 1 | 1 | 1 | 1 | 1 | 1 | 1 | 1 | 1 |
| E8 | 1 | 1 | 1 | 1 | 1 | 1 | 1 | 1 | 1 |

Further, the statistical flow table A1 can be updated according to the sub-flow entry table SA2. To avoid ambiguity, the statistical flow table updated from the statistical flow table A1 is denoted as a statistical flow table A2 hereafter. The statistical flow table A2 can be written as

Statistical flow table A2

| Type | 100011111 | 100110000 | 111110000 | 111111111 |
|---|---|---|---|---|
| statistical | 2 | 1 | 3 | 2 |
| quantity field | | | | |
| of the flow | | | | |
| entry vectors | | | | |
| index field | sub-flow | new | new | sub-flow |
| | entry | sub-flow | sub-flow | entry |
| | table SA | entry | entry | table SA |
| | | table SB | table SB | |
| quantity field | 112 | 96 | 0 | 0 |
| of insignificant | | | | |
| bits (per flow) | | | | |
| total number | 224 | 96 | 0 | 0 |
| of insignificant | | | | |
| bits field | | | | |

Here, in the statistical flow table A2, the sub-flow entry table SA and the new sub-flow entry table SB illustrated in the index field are two different paths for storing flow entry vectors. In the present invention, the sub-flow entry table SA1 and the sub-flow entry table SA2 are two updated versions from the sub-flow entry table SA. For presentation simplicity, a storage path shown in the index field is indicated as “sub-flow entry table SA” for locating several updated sub-flow entry table SA with the same memory address. Similarly, the new sub-flow entry table SB1 is an updated version from the new sub-flow entry table SB. Thus, a storage path shown in the index field is indicated as “new sub-flow entry table SB” for locating several new sub-flow entry table SB with the same memory address.

As mention previously, a flow entry vector E3 with the type “100110000” is deleted from the sub-flow entry table SA1. Further, the data of the flow entry vector E3 is stored in the new sub-flow entry table SB1. Additionally, only a match field set corresponding to a bit set {1,0,0,1,1} is stored in the new sub-flow entry table SB1 since all elements of a bit set {0,0,0,0} are insignificant bits. For the new sub-flow entry table SB1, only two insignificant match fields (i.e., {ETH_DST, ETH_SRC}) corresponding to the flow entry vector E3 are introduced to the new sub-flow entry table SB1. According to Table 1, the match field ETH_DST and the match field ETH_SRC both require 48 bits. Thus, the number of insignificant bits in the new sub-flow entry table SB1 corresponding to the flow entry vector E3 is 96. Therefore, in the statistical flow table A2, each flow entry vector categorized as type “100110000” has 96 insignificant bits. The total number of insignificant bits of the type “100110000” is 96×1=96.

In the embodiment, the (original) sub-flow entry table SA has the flow entry vectors E1 to E8. Each flow entry vector requires 288 bits. Thus, if data compression is not performed, the second memory device 17 requires 248×8=1984 bits for storing the flow entry vectors E1 to E8. By executing step S301 to step S313, the (original) sub-flow entry table SA is updated to the sub-flow entry table SA2. Further, the sub-flow entry table SA2 can also use the new sub-flow entry table SB1 for jointly storing the flow entry vectors E1 to E8. However, only four flow entry vectors (E1, E2, E7, and E8) are stored in the sub-flow entry table SA2. Thus, the sub-flow entry table SA2 requires 248×4=992 bits. The new sub-flow entry table SB1 includes match fields {IN_PORT, ETH_DST, ETH_SRC, ETH_TYPE, IP_PROTO} of the flow entry vectors (E3, E4, E5, and E6). Thus, new sub-flow entry table SB1 requires (32+48+48+16+8)×4=608 bits. In other words, by using data compression in step S301 to step S313, the second memory device 17 only requires 992+908=1600 bits for storing the flow entry vectors E1 to E8. In the embodiment, a compression ratio (CR) is equal to (1600/1984)=0.8. In other words, the second memory device 17 only provides 80% memory capacity for storing the flow entry vectors E1 to E8 without any information loss.

To sum up, the present invention provides a method of accessing data for a switch in order to improve memory utilization of a ternary content address memory device and mitigate transmitted delay caused by negotiating with a network controller frequently. The method of accessing data is performed by using several heterogeneous tables. Specifically, data compression can also be applied to improve data accessing efficiency. In the original sub-flow entry table, numerous insignificant bits may exist in some flow entry vectors, thereby requiring large memory capacity. To perform data compression without any information loss, the significant bits of these “sparse” flow entry vectors are selected to be stored in the new sub-flow entry table. As a result, these “sparse” flow entry vectors can be completely deleted from the original sub-flow entry table. Therefore, numerous insignificant bits of the “sparse” flow entry vectors are equivalently eliminated for releasing the memory capacity. As a result, the method of accessing data outperforms the conventional method in high data compression efficiency without any hardware modification. Since the available memory capacity can be increased, transmission delay can be mitigated.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of accessing data for a switch, the switch comprising a control circuit and a chip circuit, the chip circuit comprising a plurality of first memory devices, the control circuit comprising a second memory device, the method comprising:
vectorizing a flow entry received by the switch for generating a flow entry vector;
matching the flow entry vector and a stored vector of each first memory device of the plurality of first memory devices for selecting a buffer address of the flow entry vector; and
moving partial data from a first memory device to the second memory device when the first memory device of the plurality of first memory devices is selected to store the flow entry vector and a utilization factor of the first memory device is greater than a predetermined value.

2. The method of claim 1, wherein the flow entry vector is a binary vector, and matching the flow entry vector and the stored vector of each first memory device of the plurality of first memory devices for selecting the buffer address of the flow entry vector comprises:
matching an inner product of the flow entry vector and a cross product between the stored vector of each first memory device of the plurality of first memory devices and the flow entry vector; and
buffering the flow entry vector to the first memory device when the inner product of the flow entry vector is equal to the cross product between a stored vector of the first memory device and the flow entry vector.

3. The method of claim 1, further comprising:
acquiring a plurality of flow entries;
generating a plurality of flow entry vectors according to the plurality of flow entries;
establishing a statistical flow table, wherein the statistical flow table comprises a statistical quantity field of the flow entry vectors, an index field, a quantity field of insignificant bits, and a total number of insignificant bits field; and
buffering at least one flow entry vector to a sub-flow entry table of the second memory device according to the index field.

4. The method of claim 3, further comprising:
acquiring a field set of a flow entry vector with maximum total number of insignificant bits according to the total number of insignificant bits field;
acquiring a sub-field set corresponding to significant bits from the field set;
establishing a new sub-flow entry table according to the sub-field set;
moving data of the sub-field set from the sub-flow entry table to the new sub-flow entry table; and
deleting the data of the sub-field set and data of the insignificant bits field from the sub-flow entry table.

5. The method of claim 4, further comprising:
updating the statistical quantity field of the flow entry vectors, the quantity field of insignificant bits, and/or the total number of insignificant bits field of the statistical flow table.

6. The method of claim 4, further comprising:
calculating a data compression improvement factor, wherein the data compression improvement factor is a ratio of a number of insignificant bits of the flow entry vector with maximum total number of insignificant bits to a total number of insignificant bits of the sub-flow entry table.

7. The method of claim 6, further comprising:
selecting an additional flow entry vector from the sub-flow entry table;
acquiring an additional field set corresponding to significant bits of the additional flow entry vector;
moving data of the additional field set to the new sub-flow entry table; and
deleting the data of the additional field set from the sub-flow entry table;
wherein the additional field set is a sub-set of the field set.

8. The method of claim 1, further comprising:
searching data stored in the plurality of first memory devices of the chip circuit in order to compare information of an output packet with information of flow entries stored in the plurality of first memory devices; and
transmitting the output packet from the switch when the information of the output packet and the information of flow entries stored in the plurality of first memory devices are consistent.

9. The method of claim 1, further comprising:
searching data stored in the plurality of first memory devices of the chip circuit in order to compare information of an output packet with information of flow entries stored in the plurality of first memory devices;
generating a request message to the control circuit when the information of the output packet and the information of flow entries stored in the plurality of first memory devices are inconsistent;
searching data stored in the second memory device of the control circuit in order to compare information of the output packet with information of flow entries stored in the second memory device; and
transmitting the output packet from the switch when the information of the output packet and the information of flow entries stored in the second memory device are consistent.

10. The method of claim 1, further comprising:
searching data stored in the plurality of first memory devices of the chip circuit in order to compare information of an output packet with information of flow entries stored in the plurality of first memory devices;
generating a request message to the control circuit when the information of the output packet and the information of flow entries stored in the plurality of first memory devices are inconsistent;
searching data stored in the second memory device of the control circuit in order to compare information of the output packet with information of flow entries stored in the second memory device; and
negotiating with a network controller coupled to the switch when the information of the output packet and the information of flow entries stored in the second memory device are inconsistent.
